(19) United States
(12) Patent Application Publication
(10) Pub. No.: US 2011/0147017 A1
(43) Pub. Date: Jun. 23, 2011

(54) fire extinguishing system

(76) Inventor: Muzaffer Saglam, Antalya (TR)

(21) Appl. No.: 13/060,280

(22) PCT Filed: Nov. 25, 2008
(86) PCT No.: PCT/TR08/00133

§ 371 Date: Feb. 24, 2011

(51) Int. Cl. A62C 3/00; A62C 3/07

(52) U.S. Cl. 169/62; 169/65

(57) ABSTRACT

This invention relates to a fire extinguishing system (1) consisting of a developed fire extinguisher (2) for the kitchens and vehicles (sea and land) which increases the safeties of the users and provides a productive using by having a control box (4) connected to it and placed to a far place from the area where the fire may occur and triggering the fire extinguisher (2) in the course of fire.

### TECHNICAL AREA

This invention relates to a fire extinguishing system providing a using system with the connected button placed to a far place from the area where the fire may occur which increases the safeties of the users and providing a productive using by means of a triggering the fire extinguisher in the course of fire.

### PREVIOUS TECHNIQUE

In our recent days, there are many applications developed in order to extinguish the fire occurring in the cookers, cooking appliances and in the similar appliances taking place in the kitchens and especially in the industrial kitchens. These applications generally have the structure of having the fume hood and fire extinguishing devices connected to each other and they provide the discharge of the liquid in the fire extinguisher unto the cooker over the fume hood by means of the detectors during the occurrence of the fire.

This way, the implementation of the fire fighting which may occur in the cooking section becomes possible sooner and in an efficient way. However, at the points where the detectors detect the fire lately or in the event of having malfunctions of the detectors, the fire has to be extinguished by the interventions of the users by using the fire extinguishers. Positioning the fire extinguisher near to the fume hood causes difficulties on the users to reach the fire extinguishers at the moment of fire and his situation decreases the safety of the user. In order to meet these kinds of issues, there are buttons/control boxes placed to a far place from the cooking section by having them connected to the fire extinguisher. But, these types of control boxes and buttons only function to extinguish the fire when the fire takes place. There have been several developments in the Technique in order to meet the needs because of such reasons.

In Technique and in the Patent Document number TR 2006 05246 of Turkish Patent is mentioned as the known application for a pipe placed in the fume hood and Melting at 180 degree during the course of the fire and triggering the valve and causing the foam taking place in the fire extinguisher to come out from the nozzles on the fume hood and additionally, having the feature to work automatically as well as becoming active with the manual intervention of the user to the buttoned-valve taking place on the extinguisher's valve. But, when the user wants to intervene manually in the said system, the close location of the fire extinguisher to the fume hood does not provide safety for the user.

One of the known applications in the technique is the patent document number U.S. Pat. No. 3,653,443 of the patent of United States and in that document, it is mentioned that the fire extinguisher is placed in the fume hood and placing a button to a far place from the section where a fire may occur (cooking section). When the button taking place in the said system is pressed by the user during the course of the fire, it only triggers the fire extinguisher and in the result of this the fire extinguisher liquid reaches cooking section over the fume hood. But the Button operates mechanically and it does not cut off the electricity and gas system during the fire and together with this, it can not show to the users that the system is always operational/working status.

The other known applications in the technique are the patent document CN 2430323 numbered Chinese patent document, JP 7275387 numbered Japanese patent document and TW 509157 numbered Taiwan patent document and fire extinguishing systems used in the Vehicles are mentioned in these documents. But, in the said documents, it is not mentioned that there is a Melting pipe when it detects the fire (heating) on the body of the vehicle and that there is a control box within the vehicle which is easily accessible by the users and providing the controlling of the user's safety.

As stated above, in the known applications of the techniques, the buttons taking place in the fire extinguishing systems and the cut-off of the electricity and gas during the fire and showing the system's operational/working status at all times is not mentioned.

### BRIEF EXPLANATION OF THE INVENTION

The purpose of this invention is to accomplish a fire extinguishing system in order to increase the safety of the user more at the stage of fire extinguishing and to implement a fire extinguishing system providing more productive way of using.

Another purpose of this invention is to implement a fire extinguishing system having a control box providing the cut-off of the electricity and gas during the course of the moment of fire.

One other purpose of his invention is to implement a fire extinguishing system having a control box showing that the system is in operational/working status at all times.

### DETAILED EXPLANATION OF THE INNOVATION

Fire extinguishing system implemented to reach the purposes of his invention is shown in the attached figures.

These figures are as stated below;

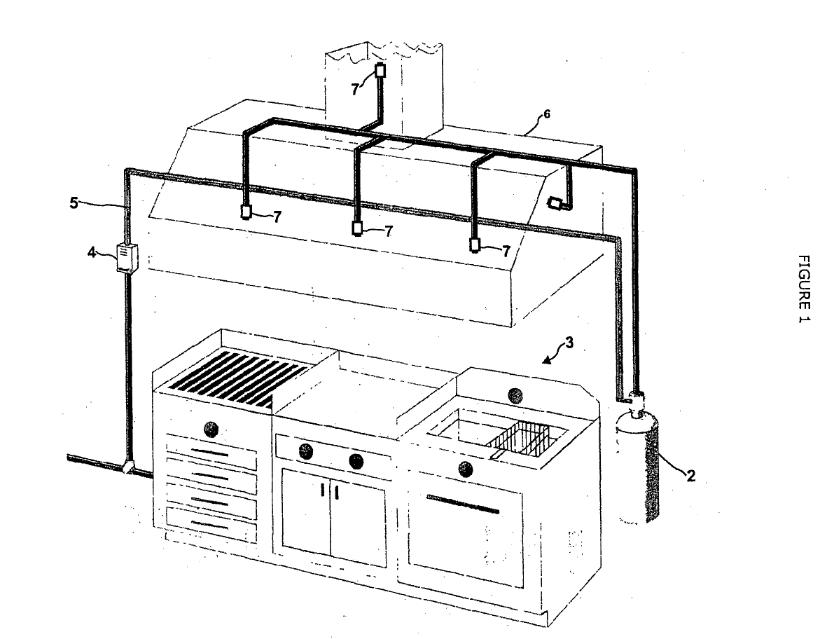

FIG. 1 is the perspective view of the fire extinguishing system subjected to the invention.

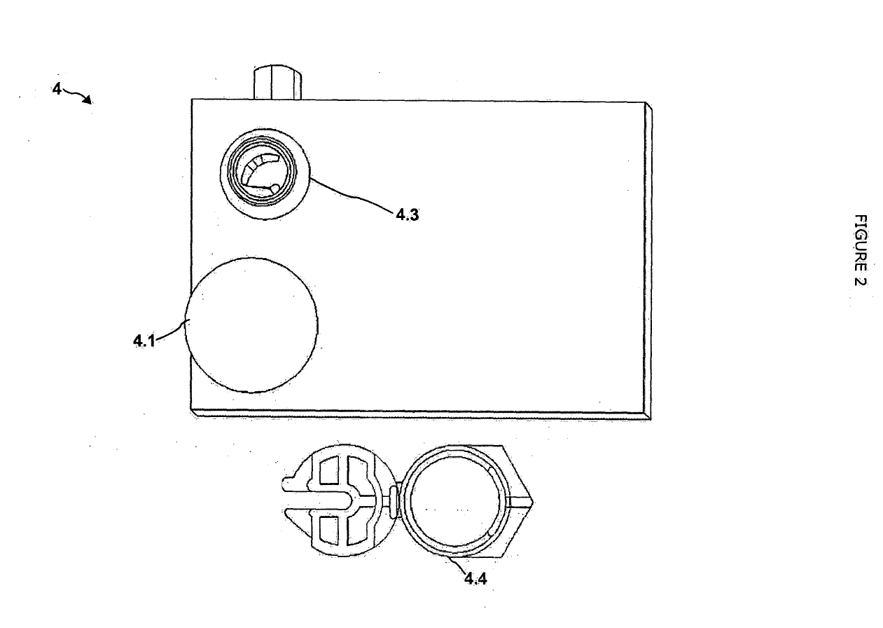

FIG. 2 is the perspective view of the control box belonging to the fire extinguishing system subjected to the invention.

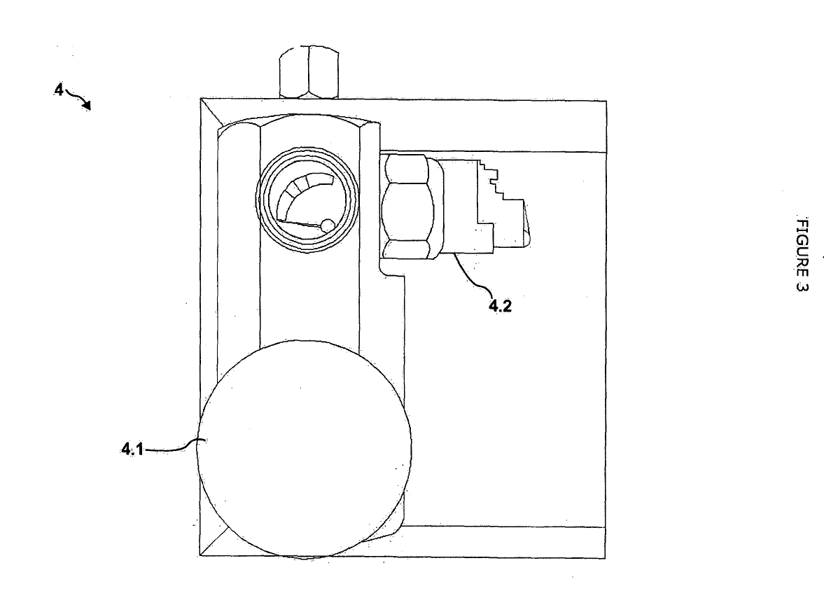

FIG. 3 is the cross-section view of the control box belonging to the fire extinguishing system subjected to the invention.

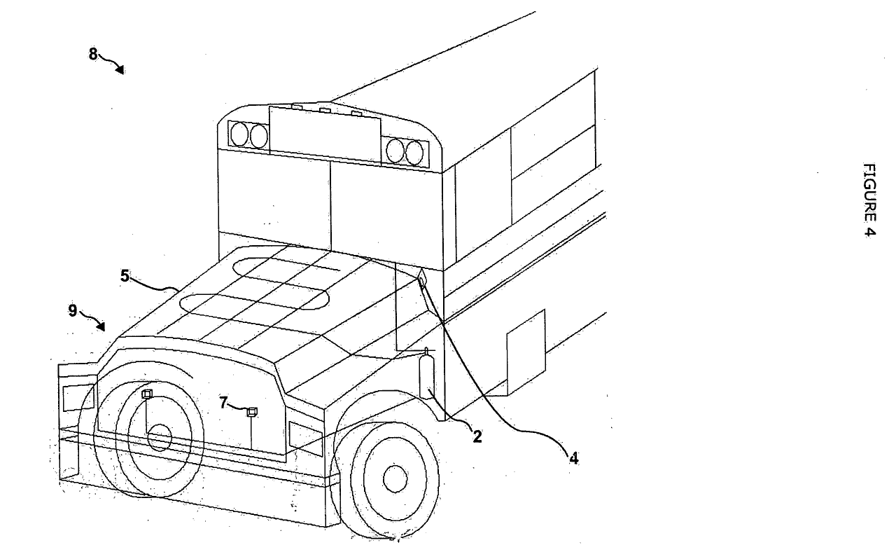

FIG. 4 is the view of another application of the fire extinguishing system subjected to the invention.

The parts configuring the subjected fire extinguishing system are numbered in the attached figures as shown below:
1—Fire Extinguishing System
2—Fire Extinguisher
3—Cooking Hopper
4—Control Box
   4.1—Button
   4.2—Key
   4.3—Manometer
   4.4—Pin
5—Melting Pipe
6—Fume Hood
7—Nozzle
8—Vehicle
9—Motor Chamber

Invention's Subject of Fire Extinguishing System (1) most basically contains at least one fire extinguisher (2) having fire extinguishing liquid in it,
at least one pipe (5) taking place in the cooking hopper (3) which melts from the heat occurring when the fire takes place and triggering the fire extinguisher (2) by means of the pressure in it and one end connected to the fire extinguisher (2) and the other end connected to the control box (4),
at least one nozzle (7) placed in the fume hood (6) and pouring the extinguishing liquid unto the cooking hopper (3) when the fire extinguisher (2) is triggered by the pipe (5),
at least one control box (4) providing the manual operation of the system by the user when a technical issue occurs, being connected to the main extinguishing system, providing the safety of the user by having it placed to a far place and preventing the expansion of the fire by cutting-off the electricity and gas.

When the button (4.1) taking place in the Control Box (4) belonging to the invention's subject of Fire Extinguishing System (1) is pressed, it contains a pressure switch (4.2) decreasing the pressure and cutting off the electricity and gas.

The Control Box (4) belonging to the invention's subject of Fire Extinguishing System (1) contains a manometer (4.3) on it which shows that the system is in operational/working status.

The Control Box (4) belonging to the invention's subject of Fire Extinguishing System (1) contains the security pin under the button (4.1) and preventing the involuntary operation of the button (4.1) by the user.

When the button (4.1) is desired to be operated by the user, the security pin (4.4) is pulled downwards by the user and his way the button (4.1) is released.

In another application of the invention vehicles (sea and land) (8) contain at least one control box (4) in the engine room (9) with the nozzle (7) and melting pipe (5) circulated around the motor and providing the manual (by the hand) operation of the system when a technical problem occurs during the fire and providing the security of the user by being connected to the main extinguishing system and placed in the driver's area and preventing the expansion of the fire by cutting off the electricity and gas.

In the scope of the basic concept, it is possible to develop many types of applications of the Fire Extinguishing System (1) and the invention can not be restricted with the explained examples and essentially it is as specified in the claims.

1. In it's most basic status, this invention is characterized with at least one fire extinguisher (2) having extinguishing liquid in it, at least one pipe (5) taking place in the cooking hopper (3) and having it's one end connected to the fire extinguisher (2) and the other end connected to the control box (4) which melts when the fire occurs from the occurrence of the heat and triggering the fire extinguisher (2) by means of the pressure contained in it and et least one nozzle (7) placed in the fume hood (6) which pours the extinguishing liquid unto the cooking hopper (3) when the fire extinguisher (2) is triggered by the pipe (5) and containing one control box (4) providing the manual operation of the system by the user when a technical issue arises during the fire and being connected to the main fire extinguishing system and providing the safety of the user by being placed. in a far place from the cooking hopper (3) and preventing the expansion of the fire by cutting of the electricity and gas.

2. This is a fire extinguishing system (1) as stated in claim 1 which is characterized by cutting of the electricity and gas with its pressure switch (4.2) when the button (4.1) taking place in the control box (4) is pressed by the user by decreasing the pressure.

3. A Fire Extinguishing System (1) as stated in the above claims as characterized with a manometer (4.3) on the Control Box (4) and showing the operational/working status of the system.

4. A Fire Extinguishing System (1) as stated in the above claims as characterized by the security pin taking place under the button (4.1) of the Control Box (4) which prevents involuntary using of the user.

5. A Fire Extinguishing System (1) for another application of the invention taking place in the engine rooms (9) of the vehicles (sea and land vehicles) (8) by having a nozzle (7) and melting pipe (5) circulated around the motor providing the manual (by the hand) operation of the system when a technical problem occurs during the fire and providing the security of the user by being connected to the main extinguishing system characterized with at least one Control Box (4) placed in the driver's area preventing the expansion of the fire by cutting off the electricity and gas.
